(19) United States
(12) Patent Application Publication
(10) Pub. No.: US 2020/0299507 A1
(43) Pub. Date: Sep. 24, 2020

(54) COMPOSITION COMPRISING THERMOPLASTIC POLYMER AND COPPER-BASED STABILIZER, AND PRODUCTION AND USE THEREOF

(71) Applicant: Arkema France, Colombes (FR)

(72) Inventors: Philippe Blondel, Bernay (FR); Thibaut Montanari, Menneval (FR); Fabrice Glasson, Beaumontel (FR); Thierry Briffaud, Bernay (FR)

(73) Assignee: Arkema France, Colombes (FR)

(21) Appl. No.: 16/088,473

(22) PCT Filed: Apr. 7, 2017
(86) PCT No.: PCT/FR2017/050839

§ 371 Date: Sep. 26, 2018

(30) Foreign Application Priority Data
Apr. 8, 2016 (FR) 16 53123

(51) Int. Cl. C08L 77/02; B32B 1/08; B32B 5/02; B32B 15/06; B32B 15/085; B32B 15/088; B32B 15/092; B32B 27/22; B32B 27/32; B32B 27/34; B32B 27/38; B32B 27/20; E21B 17/00

(52) U.S. Cl. CPC C08L 77/02; B32B 2307/308; B32B 5/02; B32B 15/06; B32B 15/085; B32B 15/088; B32B 15/092; B32B 27/22; B32B 27/32; B32B 27/34; B32B 27/38; B32B 27/20; E21B 17/00; C08L 2203/18; C08L 2201/08; B32B 2250/40; B32B 2597/00; B32B 2307/704; B32B 2260/021; B32B 2260/046; B32B 2262/101; B32B 2262/106; B32B 2270/00; B32B 2274/00; B32B 2307/54; B32B 1/08

(57) ABSTRACT

The present invention relates to the use of a composition comprising: 70 to 91% by weight of at least one semi-crystalline polyamide, 5 to 25% by weight of at least one polyolefin having an epoxy, anhydride or acid function introduced by grafting or copolymerisation, 3 to 20% by weight of at least one plasticizer, 0.05 to 5% by weight of at least one stabilizer on the basis of a copper complex, and at least one catalyst, said composition being free from alkaline metal halide and oligo- or polycarbodiimide, as sealing layer in a pipe containing oil or gas, the pipe being used in the exploitation of offshore oil or gas reservoirs.

The present invention relates to the use of a composition comprising at least one copper-based stabilizer with a matrix comprising at least one catalyzed thermoplastic polymer, especially a semicrystalline polyamide, as a leaktight layer in a pipe, in particular a hose pipe, containing oil or gas, this pipe being used in the exploitation of undersea (offshore) oil or gas deposits.

The present invention also relates to the composition as defined above.

The invention also relates to the structures obtained from said compositions.

The exploitation of offshore oil deposits subjects the materials employed to extreme conditions, in particular the pipes connecting the various undersea devices of the platform and conveying the hydrocarbons extracted, which are generally transported at high temperature and high pressure (for example 700 bar).

During the operation of the plants, acute problems of mechanical strength, thermal resistance and chemical resistance of the materials employed are thus posed. Such pipes must in particular withstand oil which is hot, gas, water and mixtures of at least two of these products for periods of time which may be up to 20 years.

Conventionally, these pipes comprise a nonleaktight inner metal layer formed by a helically wound profiled metal strip, such as an interlocked metal strip. This inner metal layer, which gives shape to the pipe, is coated, generally by extrusion, with a polymer layer intended to confer leaktightness. Other protective and/or reinforcing layers, such as plies of metal fibers, thermoplastics and rubbers, may also be positioned around the leaktight polymer layer.

The leaktight polymer sheath covering the carcass generally has specifications that are particularly difficult to meet since it ensures the leaktightness of the tubes while it is in direct contact with the products transported at elevated pressure and temperature. This sheath must mainly:
be able to be extruded continuously, optionally on the inner carcass support,
be flexible enough to accept bends imposed on the hose during the operations of manufacturing, installing and using the hose on the site (movement of the sea swell or raising of the hose for a change of worksite),
withstand creep following pressure exertions, aggravated by the temperature level. Creep takes place in the butt spaces (space or gap) between the metallic armorings (for example T or interlocked auto zeta) on which the sheath bears when the conduit is pressurized by the transported effluent,
be sufficiently chemically stable so that its mechanical characteristics and its leaktightness do not prohibitively degrade during the service life of the hose.

For working temperatures below 40° C., the polymer is crosslinked or noncrosslinked HDPE (high-density polyethylene). For temperatures above 40° C., polyamide is used and, for temperatures above 90° C., PVDF (polyvinylidene fluoride) is employed.

In view of the high cost of PVDF, and despite the implication of higher temperatures than those recommended, the choice of the polymer has fallen on polyamides, such as PA11 and PA12, which are well known for their good heat resistance, their chemical resistance, in particular toward solvents, their resistance to bad weather and to radiation, their impermeability to gases and liquids, and their nature as electrical insulators.

These polyamides are already commonly used in the manufacture of pipes intended to convey hydrocarbons extracted from undersea (offshore) or onshore oil deposits, but, nevertheless, have the drawback of aging too quickly.

In order to overcome this disadvantage and thus to improve the resistance to aging of these polyamide-based pipes, the document US 2003/0220449, on behalf of the applicant company, provides a composition comprising a mixture of PA, of plasticizer and of an elastomer chosen from nitrile/butadiene rubber (NBR) and hydrogenated nitrile/butadiene rubber (H-NBR).

The use of an elastomer of the NBR or H-NBR type in the compositions described in US 2003/0220449 offers several advantages in comparison with the prior compositions solely based on polyamide and plasticizer.

In particular, the introduction of one or other of these elastomers makes it possible to significantly increase the resistance to aging of the hose pipes comprising such a layer, especially by limiting the content by weight of plasticizer.

However, H-NBR (or hydrogenated NBR) elastomers are expensive and necessitate, like their nonhydrogenated NBR homologs, the implementation of a preliminary milling step, adding a further additional cost to that already generated by the NBR or H-NBR starting material.

To overcome the above drawbacks, the Applicant describes, in WO 08/122743, the use of a composition comprising at least one semicrystalline polyamide, a functionalized polyolefin and a plasticizer for the manufacture of hose pipes used in particular for the exploitation of oil or gas deposits. However, the service life of these pipes with respect to hydrolysis is still insufficient depending on the exploitation conditions of the deposits.

Moreover, US 2008/314471 describes compositions comprising a polyamide, a catalyst and optionally additives, among which stabilizers are indicated, and also optionally a chain extender.

Among the stabilizers, copper salts or a copper complex are described.

It is thus well known from the prior art, especially from patent U.S. Pat. No. 5,360,888 that polyamides may be protected against heat-mediated and light-mediated destruction at high temperatures by adding copper salts, phosphorus-based organic compounds, phenolic antioxidants and aliphatic or aromatic amines. The copper salts used are frequently Cul/Kl complexes.

U.S. Pat. No. 5,360,888 more particularly describes the use of sterically hindered aromatic carbodiimides for giving polyamides resistance to hydrolysis at high temperature.

Patent application US 2013/0171388 also describes PA materials with oligo- or polycarbodiimides. However, these compositions also have high polydispersity indices and thus a large number of branchings, the consequence of which is that high solution viscosities are produced.

Patent CA 2347258 describes the use of complexes of copper and of halogenated compounds for stabilizing polyamides. The preferred polyamides are PA6 or PA66. Said document is totally silent regarding the preparation of offshore pipes and also the working temperature and service life of such pipes.

However, the current polyamide compositions generally only allow a pipe working temperature of 60° C. to 70° C., depending on the pH or on the total acid number (TAN) of the transported fluid and on the acceptance criterion used.

There is thus a need to find a compromise between these various parameters and moreover to increase the working temperature of the pipes and also to increase the heat resistance while at the same time conserving good extrudability of the composition and the flexibility properties of the pipe.

A first subject of the invention is thus the use of a composition comprising at least one copper-based stabilizer with a matrix comprising at least one catalyzed thermoplastic polymer, especially a semicrystalline polyamide, as a leaktight layer in a pipe, in particular a hose pipe, containing oil or gas, this pipe being used in the exploitation of undersea (offshore) oil or gas deposits.

A second subject also relates to the provision of a composition as defined above.

The invention also relates to the provision of structures, especially pipes, in particular hose pipes, defined above.

Use

The present invention relates to the use of a composition comprising:
from 70% to 91% by weight, preferably from 75% to 87% by weight, of at least one semicrystalline polyamide with a mean number of carbon atoms per nitrogen atom, noted Nc, of greater than or equal to 7.5, advantageously between 9 and 18 and preferentially between 10 and 18,
from 5% to 25% by weight, advantageously from 8% to 15%, preferably from 8% to 12% by weight, of at least one polyolefin comprising an epoxy, anhydride or acid function, introduced by grafting or by copolymerization, and
from 3% to 20% by weight, preferably from 4% to 12% by weight, of at least one plasticizer,
from 0.05% to 5% by weight, preferably from 0.05% to 1% by weight, preferably from 0.1% to 1% by weight, of at least one stabilizer based on a copper complex,
at least one catalyst,
   said composition being free of alkali metal halide and of oligo- or poly-carbodiimide, as leaktight layer in a pipe containing oil or gas, this pipe being used in the exploitation of undersea (offshore) oil or gas deposits.

The inventors have found, entirely unexpectedly, that the combination of a copper complex with polyolefins and plasticizers, in combination with a catalyzed semicrystalline polyamide (PAsc), especially a polyamide, makes it possible to obtain compositions with good extrusion properties, excellent better heat resistance and also an improved working temperature of the pipes and thus better resistance to hydrolysis.

Throughout the description, unless otherwise indicated, all the percentages indicated are weight percentages.

The term “semicrystalline polyamide” covers homopolyamides and also copolyamides which have both a glass transition temperature Tg and a melting point Tm.

The nomenclature used to define polyamides is described in the standard ISO 1874-1:1992 “Plastics—Polyamide (PA) molding and extrusion materials—Part 1: Designation”, in particular on page 3 (tables 1 and 2), and is well known to those skilled in the art.

For the purposes of the invention, a semicrystalline polyamide denotes a polyamide which has a melting point (Tm) in DSC according to the standard ISO 11357-3 of 2011, and an enthalpy of crystallization during the cooling step at a rate of 20 K/min in DSC measured according to the standard ISO 11357-3 of 2013 which is greater than 30 J/g, preferably greater than 40 J/g.

The term “semicrystalline polyamides” is especially directed toward aliphatic homopolyamides resulting from the condensation:
of a lactam,
of an aliphatic α,ω-aminocarboxylic acid,
of a Ca diamine and a Cb diacid.

When the polyamide is a unit corresponding to the formula (Ca diamine).(Cb diacid), Ca and Cb denoting the number of carbon atoms in the diamine and the diacid, respectively, the (Ca diamine) unit is chosen from linear or branched aliphatic diamines, cycloaliphatic diamines and alkylaromatic diamines.

When the diamine is aliphatic and linear, of formula H₂N—(CH₂)ₐ—NH₂, the (Ca diamine) monomer is preferably chosen from butanediamine (a=4), pentanediamine (a=5), hexanediamine (a=6), heptanediamine (a=7), octanediamine (a=8), nonanediamine (a=9), decanediamine (a=10), undecanediamine (a=11), dodecanediamine (a=12), tridecanediamine (a=13), tetradecanediamine (a=14), hexadecanediamine (a=16), octadecenediamine (a=18), octadecenediamine (a=18), eicosanediamine (a=20), docosanediamine (a=22) and diamines obtained from fatty acids.

When the diamine is aliphatic and branched, it may comprise one or more methyl or ethyl substituents on the main chain. For example, the (Ca diamine) monomer may advantageously be chosen from 2,2,4-trimethyl-1,6-hexanediamine, 2,4,4-trimethyl-1,6-hexanediamine, 1,3-diaminopentane, 2-methyl-1,5-pentanediamine and 2-methyl-1,8-octanediamine.

When the (Ca diamine) monomer is cycloaliphatic, it is chosen from bis(3,5-dialkyl-4-aminocyclohexyl)methane, bis(3,5-dialkyl-4-aminocyclohexyl)ethane, bis(3,5-dialkyl-4-aminocyclohexyl)propane, bis(3,5-dialkyl-4-aminocyclohexyl)butane, bis(3-methyl-4-aminocyclohexyl)methane (BMACM or MACM), bis(p-aminocyclohexyl)methane (PACM), isopropylidenedi(cyclohexylamine) (PACP), isophoronediamine (a=10), piperazine (a=4) and aminoethylpiperazine. It may also comprise the following carbon backbones: norbornylmethane, cyclohexylmethane, dicyclohexylpropane, di(methylcyclohexyl), di(methylcyclohexyl)propane. A nonexhaustive list of these cycloaliphatic diamines is given in the publication “Cycloaliphatic Amines” (Encyclopedia of Chemical Technology, Kirk-Othmer, 4th Edition (1992), pages 386-405).

When the (Ca diamine) monomer is alkylaromatic, it is chosen from 1,3-xylylenediamine and 1,4-xylylenediamine.

The (Cb diacid) unit is chosen from linear or branched aliphatic diacids, cycloaliphatic diacids and aromatic diacids.

When the (Cb diacid) monomer is aliphatic and linear, it is chosen from succinic acid (b=4), pentanedioic acid (b=5), adipic acid (b=6), heptanedioic acid (b=7), octanedioic acid (b=8), azelaic acid (b=9), sebacic acid (b=10), undecanedioic acid (b=11), dodecanedioic acid (b=12), brassylic acid (b=13), tetradecanedioic acid (b=14), hexadecanedioic acid (b=16), octadecanedioic acid (b=18), octadecenedioic acid (b=18), eicosanedioic acid (b=20), docosanedioic acid (b=22) and fatty acid dimers containing 36 carbons.

When the diacid is cycloaliphatic, it can comprise the following carbon backbones: norbornylmethane, cyclohexylmethane, dicyclohexylmethane, dicyclohexylpropane, di(methylcyclohexyl) or di(methylcyclohexyl)propane.

When the diacid is aromatic, it is chosen from terephthalic acid (denoted T), isophthalic acid (denoted I) and naphthalenic diacids.

When the diacid is a polymerized fatty acid, it is chosen from commercially available polymerized fatty acids and in particular the product having the trade name Pripol® sold by the company Croda, and also the product having the trade name Empol® sold by the company Cognis or the product having the trade name Unydime® sold by the company Arizona Chemical or the product having the trade name Radiacid® sold by the company Oleon.

After separation, the fatty acid dimers are obtained predominantly from 75% to more than 98% as a mixture especially with the monomer, the 1.5-mer and the corresponding trimer.

Advantageously, the semicrystalline polyamide is chosen from an aliphatic polyamide, a cycloaliphatic polyamide, an aromatic polyamide or a mixture thereof.

Advantageously, the polyamide has a Tm from 160° C. to 290° C., determined according to standard ISO 11357-3 (2013).

As indicated previously, the term “semicrystalline polyamides” also covers copolyamides, which result from the condensation of at least two of the groups of compounds mentioned above to obtain homopolyam ides.

Among the copolyamides, mention may be made especially of the copolyamide 11/10 T and the copolyamide 12/10 T.

The copolyamides of the invention also cover semicrystalline copolyamides comprising at least one minor unit derived from the polycondensation:
of at least one diamine with at least one polymerized fatty acid, in particular a fatty acid dimer, or
of a diamine dimer with at least one dicarboxylic acid, or
of an amino acid dimer,
   in particular derived from the polycondensation:
of at least one diamine with at least one polymerized fatty acid, in particular a fatty acid dimer, or
of a diamine dimer with at least one dicarboxylic acid, or mixtures thereof.

More specifically, said minor unit comprising at least one of the following formulae:
either the residues of a fatty acid dimer of formula (I) below:

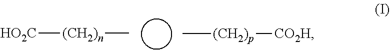

or the residues of a diamine dimer of formula (II) below:

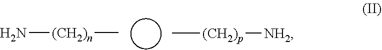

or the residues of an amino acid of formula (III) below:

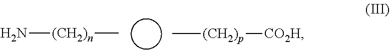

or a mixture thereof,

in which formulae, independently of each other:

n is from 1 to 10, in particular from 1 to 7, especially from 5 to 7,

p is from 1 to 10, in particular from 1 to 7, especially from 5 to 7,

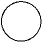

corresponds to a structure chosen from:

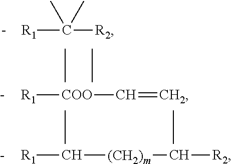

m being from 1 to 5,

R₁ and R₂ representing in said three structures, independently of each other, H or a C₁ to C₁₂ and in particular C₇ to C₁₁ alkyl chain, and

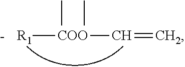

in which R₁ and R₂ are cyclized to form a structure:
i) with one ring of the type
cyclohexane:

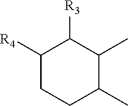

or phenyl:

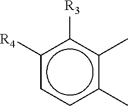

ii) with two rings of the 1,2,3,4-tetrahydronaphthalene type:

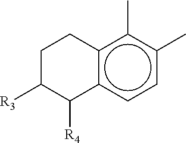

or of the bicyclo[4.4.0]decane type:

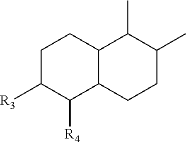

R₃ and R₄ being, in the one-ring or two-ring structures defined above,
C1to C10 and in particular C7 to C9 alkyl residues,

or a mixture thereof,

the total number of carbon atoms in the diacid of formula (I), the diamine of formula (II) and the amino acid of formula (III) being greater than or equal to 30, in particular greater than or equal to 36, in particular 36.

Advantageously, the mole proportion of said at least one minor unit in the semicrystalline copolyamide is from 1% to 20%, in particular from 1% to 10%, especially from 2% to 10% relative to the sum of all the units of said copolyam ide.

The semicrystalline polyamide, whether it is an aliphatic, cycloaliphatic or aromatic homopolyamide, or else a copolyamide, has a number of carbon atoms per nitrogen atom of greater than 7.5, advantageously between 9 and 18 and preferentially between 10 and 18.

In the case of a PA-X.Y type homopolyamide, the number of carbon atoms per nitrogen atom is the mean of the unit X and the unit Y.

In the case of a copolyamide, the number of carbons per nitrogen is calculated according to the same principle. The calculation is made on a molar pro rata basis of the various amide units.

The composition used in the context of the present invention comprises at least one semicrystalline polyamide, i.e. it may comprise a mixture of two or more of the semicrystalline polyamides from among the crystalline polyamides corresponding to the definition given above.

In particular, it may advantageously be envisaged to use a composition comprising copolyamide 11/10 T and/or copolyamide 12/10 T, as a mixture with PA11 and/or PA12.

The polyamide used in the context of the present invention may especially have a number-average molecular mass M̅n̅ generally greater than or equal to 20 000 and advantageously between 20 000 and 80 000. Its weight-average molecular mass M̅w̅ is generally greater than 40 000 and advantageously between 50 000 and 100 000; it may range up to 200 000. Its inherent viscosity (measured at 20° C. for a sample of 5×10⁻³ g/cm³ of meta-cresol) is generally greater than 0.7, preferably greater than 1.2.

The Polyolefin

The term “polyolefin” means a polymer comprising olefin units, for instance ethylene, propylene, butylene or octene units, or any other α-olefin.

Examples that may be mentioned include:
polyethylenes such as LDPE, HDPE, LLDPE or VLDPE, polypropylene or alternatively metallocene polyethylenes;
   ethylene copolymers such as ethylene/propylene copolymers, ethylene/butylene copolymers, ethylene/hexene copolymers, ethylene/octene copolymers and ethylene/propylene/diene terpolymers; and
   copolymers of ethylene with at least one product chosen from unsaturated carboxylic acid salts or esters and saturated carboxylic acid vinyl esters.

In a particularly advantageous version of the invention, the polyolefin is an ethylene elastomeric copolymer.

Such an ethylene elastomeric copolymer is a compound obtained from at least two different monomers, including at least one ethylene monomer.

Preferably, this ethylene elastomeric copolymer is chosen from an ethylene/propylene copolymer (EPR), an ethylene/butylene copolymer, an ethylene/hexene copolymer, an ethylene/octene copolymer and an ethylene/alkyl (meth)acrylate copolymer.

The ethylene/propylene copolymer (EPR) is a well-known elastomeric copolymer, obtained from ethylene and propylene monomers. EPR or EPM is described especially in the publication Ullmann's Encyclopedia of Industrial Chemistry, fifth edition, volume A 23, pages 282 to 288, the content being incorporated into the present patent application.

The ethylene/butylene copolymer is obtained from ethylene and 1-butene monomers.

The ethylene/alkyl (meth)acrylate copolymer is obtained by radical polymerization of ethylene and an alkyl (meth)acrylate. The alkyl (meth)acrylate is preferably chosen from methyl (meth)acrylate, ethyl acrylate, n-butyl acrylate, isobutyl acrylate, octyl acrylate and 2-ethylhexyl acrylate.

The polyolefin used in the context of the present invention is functionalized in the sense that it comprises at least one epoxy, anhydride or acid function, this function being introduced by grafting or by copolymerization.

The functionalized polyolefin may be chosen especially from functionalized ethylene/α-olefin copolymers and functionalized ethylene/alkyl (meth)acrylate copolymers.

The functionalized polyolefin may also be chosen from:
copolymers of ethylene, of an unsaturated epoxide and optionally of an unsaturated carboxylic acid ester or salt or of a saturated carboxylic acid vinyl ester. They are, for example, ethylene/vinyl acetate/glycidyl (meth)acrylate copolymers or ethylene/alkyl (meth)acrylate/glycidyl (meth)acrylate copolymers,
copolymers of ethylene, of an unsaturated carboxylic acid anhydride and/or of an unsaturated carboxylic acid which may be partially neutralized with a metal (Zn) or an alkali metal (Li) and optionally of an unsaturated carboxylic acid ester or of a saturated carboxylic acid vinyl ester. They are, for example, ethylene/vinyl acetate/maleic anhydride copolymers, ethylene/alkyl (meth)acrylate/maleic anhydride copolymers or ethylene/Zn or Li (meth)acrylate/maleic anhydride copolymers.

The density of the functionalized polyolefin may advantageously be between 0.86 and 0.965.

Advantageously, the polyolefin is functionalized with a carboxylic acid anhydride.

More preferentially, the functional polyolefin is chosen from an ethylene/propylene copolymer (EPR) grafted with maleic anhydride, an ethylene/hexene copolymer grafted with maleic anhydride, an ethylene/octene copolymer grafted with maleic anhydride, an ethylene/butylene copolymer grafted with maleic anhydride and an ethylene/alkyl (meth)acrylate copolymer comprising a maleic anhydride function.

As examples of ethylene/alkyl (meth)acrylate copolymers comprising a maleic anhydride function, mention may be made of terpolymers of ethylene, of alkyl acrylate and of maleic anhydride, sold especially by the Applicant under the trade name Lotader®.

The Plasticizer

The plasticizer is chosen from benzenesulfonamide derivatives, such as n-butylbenzenesulfonamide (BBSA); ethyltoluenesulfonamide or N-cyclohexyltoluenesulfonamide; hydroxybenzoic acid esters, such as 2-ethylhexyl para-hydroxybenzoate and 2-decylhexyl para-hydroxybenzoate; esters or ethers of tetrahydrofurfuryl alcohol, such as oligoethyleneoxytetrahydrofurfuryl alcohol; and esters of citric acid or of hydroxymalonic acid, such as oligoethyleneoxy malonate.

It would not be a departure from the scope of the invention to use a mixture of plasticizers.

The plasticizer that is particularly preferred is n-butylbenzenesulfonamide (BBSA).

The plasticizer may be introduced into the polyamide during the polycondensation or subsequently.

The Stabilizer Based on a Copper Complex

The term “copper complex” especially denotes a complex between a monovalent or divalent copper salt with an organic or inorganic acid and an organic ligand.

Advantageously, the copper salt is chosen from cupric (Cu(II)) salts of hydrogen halide, cuprous (Cu(I)) salts of hydrogen halide and aliphatic carboxylic acid salts.

In particular, the copper salts are chosen from CuCl, CuBr, Cul, CuCN, CuCl₂, Cu(OAc)₂ and cupric stearate.

Copper complexes are described especially in U.S. Pat. No. 3,505,285.

The composition of the invention is free of alkali metal halides such as lithium, sodium, potassium, rubidium, cesium or francium halides.

Consequently, an antioxidant such as Cul/Kl is excluded from the invention.

The Catalyst:

The term “catalyst” denotes a polycondensation catalyst such as a mineral or organic acid.

Advantageously, the weight proportion of catalyst is from about 50 ppm to about 5000 ppm, in particular from about 100 to about 3000 ppm relative to the total weight of the composition.

Advantageously, the amount of catalyst represents up to 3000 ppm, and preferably between 50 and 1000 ppm, relative to the amount of polyamide.

Advantageously, the catalyst is chosen from phosphoric acid (H₃PO₄), phosphorous acid (H₃PO₃), hypophosphorous acid (H₃PO₂) or a mixture thereof.

Advantageously, the present invention thus relates to the use defined above of at least one catalyst, in a weight proportion of catalyst from about 50 ppm to about 5000 ppm, in particular from about 100 to about 3000 ppm, relative to the total weight of the composition, and of at least one copper-based heat stabilizer with a matrix comprising at least one semicrystalline polyamide, said catalyst being chosen from phosphoric acid (H₃PO₄), phosphorous acid (H₃PO₃), hypophosphorous acid (H₃PO₂) or a mixture thereof.

Advantageously, the catalyst is chosen from phosphoric acid (H₃PO₄) and phosphorous acid (H₃PO₃) in a proportion from about 100 to about 3000 ppm.

The composition of the invention is used as leaktight layer in a pipe containing oil or gas, this pipe being used in the exploitation of undersea (offshore) oil or gas deposits.

These pipes serve not only to ensure the connections between the seabed where the wellhead is located and the surface where the oil platform is located, which performs the processing and expedition of the production, but also to convey the effluent produced by wells, in the form of liquid or gaseous products, between a storage or processing site and the place of use.

These pipes thus transport the oil production and all the products that may be associated therewith (liquid crude oil and/or gas, at elevated temperature and pressure, and also other diverse fluids such as water, methanol, etc. originating from the well).

Consequently, the term “gas” denotes a combustible gas originating from the oil well and does not in any way concern air or a mixture with air.

The pipe of the invention is neither a pneumatic pipe transporting air nor a hydraulic pipe transporting oil, especially mineral oil.

The pipe of the invention is used in the exploitation of undersea (offshore) oil or gas deposits and therefore does not concern onshore pipes either.

The compositions with catalyst comprising the constituents of table 1 below are thus explicitly disclosed in the present invention:

| | PAsc (%) | Polyolefin (%) | Plasticizer (%) | Stabilizer (%) |
|---|---|---|---|---|
| Compo 1 | 70-91 | 5-25 | 3-20 | 0.05-5 |
| Compo 2 | 70-91 | 5-25 | 3-20 | 0.05-1 |
| Compo 3 | 70-91 | 5-25 | 3-20 | 0.1-1 |
| Compo 4 | 70-91 | 8-15 | 3-20 | 0.05-5 |
| Compo 5 | 70-91 | 8-15 | 3-20 | 0.05-1 |
| Compo 6 | 70-91 | 8-15 | 3-20 | 0.1-1 |
| Compo 7 | 70-91 | 8-12 | 3-20 | 0.05-5 |
| Compo 8 | 70-91 | 8-12 | 3-20 | 0.05-1 |
| Compo 9 | 70-91 | 8-12 | 3-20 | 0.1-1 |
| Compo 10 | 70-91 | 5-25 | 4-12 | 0.05-5 |
| Compo 11 | 70-91 | 5-25 | 4-12 | 0.05-1 |
| Compo 12 | 70-91 | 5-25 | 4-12 | 0.1-1 |
| Compo 13 | 70-91 | 8-15 | 4-12 | 0.05-5 |
| Compo 14 | 70-91 | 8-15 | 4-12 | 0.05-1 |
| Compo 15 | 70-91 | 8-15 | 4-12 | 0.1-1 |
| Compo 16 | 70-91 | 8-12 | 4-12 | 0.05-5 |
| Compo 17 | 70-91 | 8-12 | 4-12 | 0.05-1 |
| Compo 18 | 70-91 | 8-12 | 4-12 | 0.1-1 |
| Compo 19 | 75-87 | 5-25 | 3-20 | 0.05-5 |
| Compo 20 | 75-87 | 5-25 | 3-20 | 0.05-1 |
| Compo 21 | 75-87 | 5-25 | 3-20 | 0.1-1 |
| Compo 22 | 75-87 | 8-15 | 3-20 | 0.05-5 |
| Compo 23 | 75-87 | 8-15 | 3-20 | 0.05-1 |
| Compo 24 | 75-87 | 8-15 | 3-20 | 0.1-1 |
| Compo 25 | 75-87 | 8-12 | 3-20 | 0.05-5 |
| Compo 26 | 75-87 | 8-12 | 3-20 | 0.05-1 |
| Compo 27 | 75-87 | 8-12 | 3-20 | 0.1-1 |
| Compo 28 | 75-87 | 5-25 | 4-12 | 0.05-5 |
| Compo 29 | 75-87 | 5-25 | 4-12 | 0.05-1 |
| Compo 30 | 75-87 | 5-25 | 4-12 | 0.1-1 |
| Compo 31 | 75-87 | 8-15 | 4-12 | 0.05-5 |
| Compo 32 | 75-87 | 8-15 | 4-12 | 0.05-1 |
| Compo 33 | 75-87 | 8-15 | 4-12 | 0.1-1 |
| Compo 34 | 75-87 | 8-12 | 4-12 | 0.05-5 |
| Compo 35 | 75-87 | 8-12 | 4-12 | 0.05-1 |
| Compo 36 | 75-87 | 8-12 | 4-12 | 0.1-1 |

In an advantageous embodiment, said pipe is flexible.

In an advantageous embodiment, the present invention relates to the use of a composition as defined above, characterized in that said copper-based complex comprises a ligand chosen from phosphines, in particular triphenylphosphines, mercaptobenzimidazole, EDTA, acetylacetonate, glycine, ethylenediamine, oxalate, diethylenediamine, triethylenetetraamine, pyridine, diphosphone and dipyridyl or mixtures thereof, in particular triphenylphosphine and/or mercaptobenzimidazole.

The phosphines denote alkylphosphines, such as tributylphosphine, or arylphosphines such as triphenylphosphine (TPP).

Advantageously, said ligand is triphenylphosphine.

Examples of complexes and also of their preparation are described in patent CA 02347258.

Advantageously, the amount of copper in the composition of the invention is from 10 ppm to 1000 ppm by weight, especially from 20 ppm to 70 ppm, in particular from 50 to 150 ppm relative to the total weight of the composition.

In an advantageous embodiment, the present invention relates to the use of a composition as defined above, characterized in that said copper-based complex also comprises a halogenated organic compound.

The halogenated organic compound may be any halogenated organic compound.

Advantageously, said halogenated organic compound is a bromine-based compound and/or an aromatic compound.

Advantageously, said aromatic compound is chosen especially from decabromodiphenyl, decabromodiphenyl ether, bromo or chloro styrene oligomers, polydibromostyrene, tetrabromobisphenyl-A, tetrabisphenyl-A derivatives, such as the epoxy derivatives, and chloro dimethanedibenzo(a,e)cyclooctene derivatives, and mixtures thereof.

Advantageously, said halogenated organic compound is a bromine-based compound.

Said halogenated organic compound is added to the composition in a proportion of from 50 to 30 000 parts per million by weight of halogen relative to the total weight of the composition, especially from 100 to 10 000, in particular from 500 to 1500 ppm.

Advantageously, the copper:halogen mole ratio is from 1: 1 to 1:3000, especially from 1:2 to 1:100.

In particular, said ratio is from 1:1.5 to 1:15.

Advantageously, the stabilizer based on a copper complex is chosen from a Bruggolen® H3386, a Bruggolen® H3376, a Bruggolen® H3344 and a Bruggolen® H3350, in particular a Bruggolen® H3386.

The composition of the invention may be prepared by mixing all the compounds, followed by heating until the polyamide has melted.

Advantageously, the polyamide is heated beforehand until it has melted, and the other constituents of the composition, especially the stabilizer based on a copper complex, are then added.

Advantageously, when the copper-based stabilizer comprises a halogenated organic compound, it is then added in the form of a masterbatch in sufficient proportions to obtain the composition of the invention.

The inventors have moreover found that when conventional stabilization of Cul/Kl type is used, i.e. with an alkali metal halide, the increase in melt viscosity is inhibited, leading to a product which is not extruded without the risk of creep under their own weight in the case of large-diameter tubes. It is necessary to use a chain extender such as a carbodiimide to obtain the viscosity increase and to have an extrudable composition. However, in the case of using an antioxidant based on a copper complex, i.e. in the absence of alkali metal halide, the inventors have found that the presence of a chain extender such as a carbodiimide is not essential and the increase in melt viscosity is observed even in the absence of oligo- or poly-carbodiimide.

Advantageously, the present invention relates to the use of a composition as defined above, characterized in that said composition also comprises at least one additive chosen from impact modifiers, dyes, pigments, optical brighteners and UV stabilizers.

Said impact modifiers preferably do not correspond to the definition of the functional polyolefins described above.

These products are known per se and are usually used in polyamide-based compositions.

Among the impact modifiers, mention may be made especially of mineral or organic fillers, rubbers and core-shell compounds as described in “Plastics Additives: An A-Z Reference, published in 1998 by Chapman & Hall, London; Impact modifiers: (2) Modifiers for engineering thermoplastics, C. A. Cruz, Jr” or “Antec, 2002 Plastics: Annual Technical Conference, volume 3: Special Areas—Additives and Modifiers—Novel acrylic, weatherable impact modifiers with excellent low temperature impact performance, Claude Granel and Michael Tran”. As core-shell compounds that may be used, mention may be made of those with an elastomeric core made of crosslinked polymer based on butyl acrylate and with a hard poly(methyl methacrylate) shell.

It should be noted that when a UV stabilizer such as an HALS (hindered-amine light stabilizer) is used, this stabilizer cannot be included in the definition of the stabilizer of the invention.

The amount of these additives may represent up to 5% by weight, and advantageously between 0.5% and 2% by weight, of the total weight of the composition according to the invention.

Composition

According to another aspect, the present invention relates to a composition comprising:
from 70% to 91% by weight, preferably from 75% to 87% by weight, of at least one semicrystalline polyamide with a mean number of carbon atoms per nitrogen atom, noted Nc, of greater than or equal to 7.5, advantageously between 9 and 18 and preferentially between 10 and 18,
from 5% to 25% by weight, advantageously from 8% to 15%, preferably from 8% to 12% by weight, of at least one polyolefin comprising an epoxy, anhydride or acid function, introduced by grafting or by copolymerization, the polyolefin advantageously being an ethylene elastomeric copolymer, which is preferably chosen from an ethylene/propylene copolymer (EPR), an ethylene/butylene copolymer, an ethylene/hexene copolymer, an ethylene/octene copolymer and an ethylene/alkyl (meth)acrylate copolymer, and
from 3% to 20% by weight, preferably from 5% to 13% by weight, of at least one plasticizer,
from 0.05% to 2% by weight, preferably from 0.1% to 1% by weight of at least one stabilizer based on a copper complex,
at least one catalyst,
   said composition being free of alkali metal halide and of oligo- or poly-carbodiimide.

This composition is used for the manufacture of pipes, in particular hose pipes, used in the exploitation of undersea (offshore) oil or gas deposits.

All the characteristics defined in the “Use” paragraph are valid for the composition per se.

According to another aspect, the present invention relates to a process for preparing a composition as defined above, comprising the placing in contact:
of from 70% to 91° A by weight, preferably from 75% to 87% by weight, of at least one semicrystalline polyamide with a mean number of carbon atoms per nitrogen atom, noted Nc, of greater than or equal to 7.5, advantageously between 9 and 18 and preferentially between 10 and 18,
of from 5% to 25% by weight, advantageously from 8% to 15%, preferably from 8% to 12% by weight, of a polyolefin comprising an epoxy, anhydride or acid function, introduced by grafting or by copolymerization, the polyolefin advantageously being an ethylene elastomeric copolymer, which is preferably chosen from an ethylene/propylene copolymer (EPR), an ethylene/butylene copolymer, an ethylene/hexene copolymer, an ethylene/octene copolymer and an ethylene/alkyl (meth)acrylate copolymer, and
of from 3% to 20% by weight, preferably from 5% to 13% by weight, of a plasticizer,
of from 0.05% to 2% by weight, preferably from 0.1% to 1% by weight of a stabilizer based on a copper complex,
of at least one catalyst,
   said composition being free of alkali metal halide and of oligo- or poly-carbodiimide.

The composition used in the context of the present invention is prepared by melt mixing of the various constituents in any mixing device, and preferably an extruder.

The composition is usually recovered in the form of granules.

Similarly, all the characteristics defined above in the “Use” paragraph are valid for the process for preparing the composition.

According to yet another aspect, the present invention relates to a pipe intended to be used in the exploitation of undersea (offshore) oil or gas deposits, comprising at least one layer (1) obtained from a composition comprising:
from 70% to 91% by weight, preferably from 75% to 87% by weight, of at least one semicrystalline polyamide with a mean number of carbon atoms per nitrogen atom, noted Nc, of greater than or equal to 7.5, advantageously between 9 and 18 and preferentially between 10 and 18,
from 5% to 25% by weight, advantageously from 8% to 15%, preferably from 8% to 12% by weight, of at least one polyolefin comprising an epoxy, anhydride or acid function, introduced by grafting or by copolymerization, the polyolefin advantageously being an ethylene elastomeric copolymer, which is preferably chosen from an ethylene/propylene copolymer (EPR), an ethylene/hexene copolymer, an ethylene/octene copolymer, an ethylene/butene copolymer and an ethylene/alkyl (meth)acrylate copolymer, and
from 3% to 20% by weight, preferably from 5% to 13% by weight, of at least one plasticizer,
from 0.05% to 2% by weight, preferably from 0.1% to 1% by weight, of a stabilizer based on a copper complex,
at least one catalyst,

said composition being free of alkali metal halide and of oligo- or poly-carbodiimide.

Similarly, all the characteristics defined above in the “Use” paragraph are valid for the layer (1) based on the composition of the invention.

In an advantageous embodiment, the present invention relates to a pipe, as defined above, characterized in that the semicrystalline polyamide is chosen from PA11, PA12, aliphatic polyamides resulting from the condensation of an aliphatic diamine containing from 6 to 12 carbon atoms and of an aliphatic diacid containing from 9 to 12 carbon atoms, copolyamides 11/12 bearing either more than 90% of units 11 or more than 90% of units 12, and polyphthalamides and polyamides comprising at least one minor unit derived from the polycondensation of a diamine with a polymerized fatty acid, in particular a fatty acid dimer.

Advantageously, said pipe defined above is characterized in that it also comprises at least one second layer (2) formed from one or more metal elements, the second layer (2) being in contact with the oil or gas conveyed, the layer (1) being placed around the second layer (2) so as to ensure the leaktightness.

The layer (2) may especially be a flexible metal tube, referred to as an internal carcass, formed from at least one profile whose coils are fastened together.

Advantageously, the present invention relates to a pipe as defined above, characterized in that it also comprises at least one third layer (3), made of metal or composite material, the third layer (3) being placed around the layer (1) so as to compensate for the internal pressure of the oil or gas conveyed.

Advantageously, said pipe is flexible.

The term “composite material” means that said layer (3) is formed from at least one polyamide, which may be identical to or different from the polyamide of layer (1), also comprising continuous fibers chosen from:
mineral fibers, in particular glass fibers,
carbon fibers and carbon nanotubes,
polymeric or polymer fibers,
or mixtures of the abovementioned fibers.

Advantageously, said fibers are glass fibers or carbon fibers, especially glass fibers.

Advantageously, the proportion of continuous fibers is from 30% to 80% relative to the total weight of the composition.

Advantageously, the present invention relates to a hose pipe as defined above, characterized in that it also comprises at least one fourth protective layer (4) placed around layer (1) or, where appropriate, the third layer (3).

The protective layer may be a ply of metal fibers or of rubbers.

The present invention will now be illustrated by examples of various compositions, the use of which forms the subject of the present invention, and also by various structures of hose pipes, also in accordance with the subject of the present invention.

### DESCRIPTION OF THE FIGURE

FIG. 1 shows the change in the normal force on compositions I1 or I4 of the invention versus the comparative composition C3 (test on a DSM brand corotating conical-screw microextruder (volume of 15 mL) at 270° C. for 25 minutes).

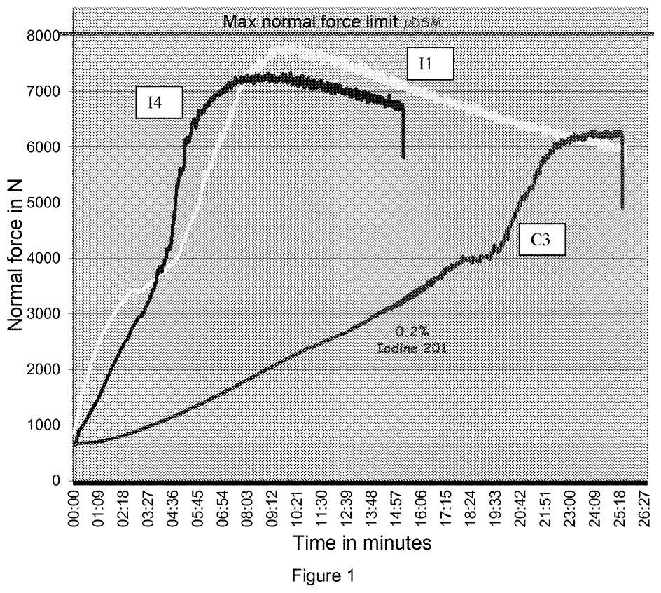

FIG. 2 shows the comparison of the hydrolysis at 140° C., pH 4 (Yvroud strips 6 mm thick) between compositions C2 and I3 and I4.

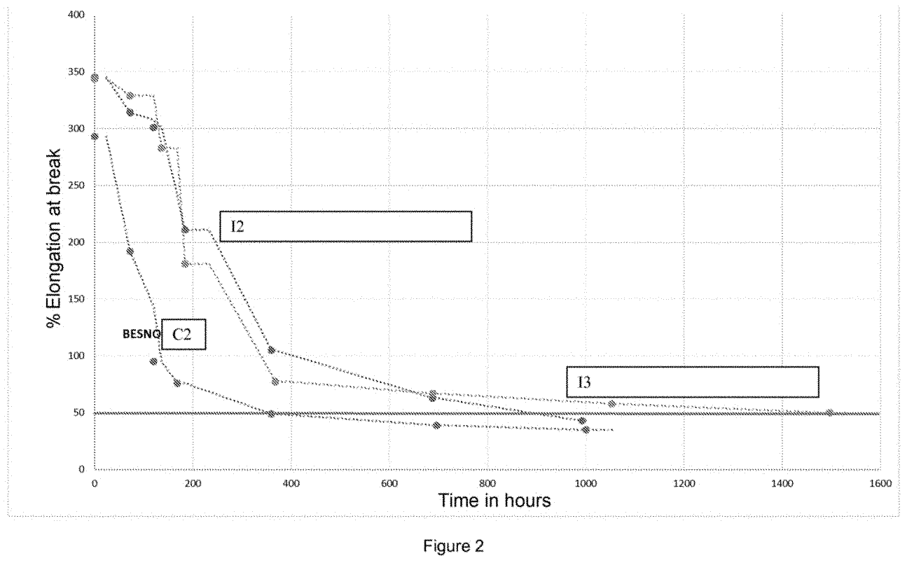

### EXAMPLES

### Products Used

The polyam ides used are PA11 of Mn (number-average molecular mass) 22 000, of inherent viscosity 1.45, of melting point 190° C., and containing 600 ppm of phosphoric acid.
Measurement of the intrinsic or inherent viscosity is performed in m-cresol. The method is well known to those skilled in the art. The standard ISO 307:2007 is followed, but changing the solvent (use of m-cresol instead of sulfuric acid), the temperature (20° C.) and the concentration (0.5% by mass).
The Mn is determined by titration (assay) of the end functions according to a potentiometric method (direct assay for NH2 or carboxyl).
The copper-based heat stabilizer of the comparative example is PolyAdd P201 from the company Polyad Services (iodine 201) (Cul/Kl).
Stabilizer based on a copper complex: Bruggolen H3386
The catalyst used is H₃PO₃ or H₃PO₄.
Anox® NDB TL89: organic stabilizer of phenol phosphite type, sold by Chemtura.
BBSA: n-butylbenzenesulfonamide, sold by Proviron.
Exxelor VA 1801: polyolefin (maleic anhydride-functionalized ethylene copolymer), sold by the company Exxon.

### Preparation of the Compositions

The products are compounded in a Werner® 40 corotating twin-screw extruder (L/D=40). This extruder comprises 10 zones numbered from F1 to F9 and the die. The feed zone F1 is not heated and a flat temperature profile at 270° C. is adopted for all the other zones.

The polyamide, the elastomeric copolymer and the stabilizer are introduced into zone F1 in the form of a dry blend.

The plasticizer (BBSA) is introduced via a metering pump into zone F6-7. Degassing under a relative vacuum of 360 mmHg is performed in zone F4.

The extrusion rate at the die outlet is 60 kg/hour for a screw spin speed of 300 rpm (revolutions per minute). The rod is granulated after cooling in a vat of water. The granules of the various tests are then dried at 80° C. for 12 hours and packaged in leaktight bags after checking the humidity contents (% water less than or equal to 0.08%).

Table I below collates the information relating to the various compounds and the respective weight percentage thereof in the compositions of tests 1 to 4 (C1, C2 and C3: comparative, and I1 to I4: invention), and also to certain parameters recorded during the extrusion (head temperatures T, head pressures P, torque). The vacuum is set so that the head pressure is constant from one test to another, at 34 bar.

TABLE 1

| | | | | I1 | I2 | I3 | I4 | |
|---|---|---|---|---|---|---|---|---|
| | References | C1 | C2 | invention | invention | invention | invention | C3 |
| Compositions | PA11 | 86.8 | 82.8 | 83.3 | 83.5 | 83.75 | 83.8 | 83.8 |
| | BBSA | 12 | 6 | 6 | 6 | 6 | 6 | 6 |
| | Stabilizer | — | — | 0.7 | 0.5 | 0.25 | 0.2 | |
| | Bruggolen | | | | | | | |
| | H3386 | | | | | | | |
| | Antioxidant | — | — | — | — | — | — | 0.2 |
| | CuI/KI | | | | | | | |
| | Antioxidant | 1.2 | 1.2 | — | — | — | — | — |
| | ANOX ® NDB | | | | | | | |
| | TL89 | | | | | | | |
| | Polyolefin | — | 10 | 10 | 10 | 10 | 10 | 10 |
| | Exxelor VA | | | | | | | |
| | 1801 | | | | | | | |

| | | |
|---|---|---|
| | Speed rpm | 300 rpm |
| | Flow rate kg/h | 60 |
| | Extruder | Werner 40 |
| | Vacuum mmHg | −700 |
| | Nominal T° C. of | 280° C. |
| | the sheaths | |
| [symbol] | T° C. Matter 1 = | 261 |
| | F3/F4 | |
| | T° C. Matter 2 = | 277 |
| | F5/F4 | |
| | T° C. Matter 3 | 281 |
| | critical = F7/F8 | |
| | T° C. matter 4 | 289 |
| | head = head | |
| | Head pressure | 34 |
| | (bar) | |
| | Torque (%) | 73 |
| | Pr. Axial (bar) | 32 |

[symbol]

indicates data missing or illegible when filed

Table III shows the results obtained on the increase in viscosity, the resistance to hydrolysis (ASTM D638 type IV dumbbells) and the thermal stability (ISO 527-2 IBA test specimens, half-life at 140° C.) for the various compositions.

### 1) Hydrolysis Test Protocol

The test specimens, ASTM D638 type IV, are cut out using a sample punch into extruded strips (Yvroud) 6 mm thick and placed in steel autoclaves. Filling with Volvic water, leaktight closure and sparging with nitrogen for at least 3.5 hours.
Placing under pressure of CO2 at 24 bar to obtain pH 4.
Installation of the autoclaves in an oven at 140° C.
Sampling of the test specimens according to the intended plan.
On each sampling the Volvic water is renewed, and the system is rendered inert and is placed under pressure.
Five test specimens are sampled and subjected to tensile testing at a speed of 50 mm/min. The elongation is measured with an extensometer. The mean elongation at break thus determined is reported as a function of the aging time.

### 2) Viscosity Increase:

The melt viscosity, determined by oscillatory rheology at 270° C. at 10 rad/sec while flushing with nitrogen with 5% deformation and shearing of 10 sec⁻¹ on a Physica MCR301 machine between two parallel plates with a diameter of 25 mm, is presented in table II below.

TABLE II

| | | | I1 | I2 | I3 | I4 | |
|---|---|---|---|---|---|---|---|
| | | | inven- | inven- | inven- | inven- | |
| References | C1 | C2 | tion | tion | tion | tion | C3 |
| Plate-plate | 40000 | 33000 | | 25000 | | | 8000 |
| 30 min 270° C. | | | | | | | |
| After 30 min | | | | | | | |
| Pa · s | | | | | | | |

TABLE III

| | C1 | C2 | I2 | C3 |
|---|---|---|---|---|
| Viscosity increase | ++ | ++ | ++ | − |
| Resistance to hydrolysis | − | + | ++ | ++ |
| 140° C. Volvic water | | | | |
| pH 4 Time in order to | | | | |
| have 50% absolute of | | | | |
| elongation at break | | | | |
| Stability to thermal | − | − | ++ | ++ |
| oxidation at 140° C. | | | | |
| Half-life | | | | |

Resistance to hydrolysis:
“−” means that the time required to reach 50% absolute of elongation at break is <300 h
“+” means that the time required to reach 50% absolute of elongation at break is >300 h and <800 h
“++” means that the time required to reach 50% absolute of elongation at break is >800 h
Thermal stability at 140° C.
“−” means that the half-life is <300 h
“+” means that the half-life is >300 h and <800 h
“++” means that the half-life is >800 h
Viscosity increase
“−” means that the value obtained is insufficient for extrusion
“+” means that the value is borderline for extrusion
“++” means that the value obtained is good for extrusion

Table III shows that the use of a stabilizer based on a copper complex makes it possible to obtain the formulation which has the best results relative to a standard copper-based heat stabilizer (C3) or an organic stabilizer of phenol phosphate type (C2), whether it is a matter of transformation, resistance to hydrolysis or heat resistance.

The inherent viscosities of the various compositions were determined according to standard ISO 307:2007 modified as above and are presented in table IV below:

TABLE IV

| | | | I1 | I2 | I3 | I4 | |
|---|---|---|---|---|---|---|---|
| | | | inven- | inven- | inven- | inven- | |
| References | C1 | C2 | tion | tion | tion | tion | C3 |
| Raw inherent | 1.61 | 1.53 | | 1.60 | | | 1.29 |
| viscosity | | | | | | | |
| meta-Cresol | | | | | | | |
| Corrected | 1.83 | 1.82 | | 1.90 | | | 1.53 |
| inherent | | | | | | | |
| viscosity | | | | | | | |
| meta-Cresol | | | | | | | |

Corrected viscosity = raw viscosity × 100/(100 − % polyolefin − % plasticizer)

1. A leaktight layer in a pipe containing oil or gas, the pipe being configured for use in the exploitation of undersea (offshore) oil or gas deposits, the leaktight layer comprising a composition comprising:
from 70% to 91% by weight, of at least one semicrystalline polyamide with a mean number of carbon atoms per nitrogen atom, noted Nc, of greater than or equal to 7.5,
from 5% to 25% by weight, of at least one polyolefin comprising an epoxy, anhydride or acid function, introduced by grafting or by copolymerization, and
from 3% to 20% by weight, of at least one plasticizer,
from 0.05% to 5% by weight, of at least one stabilizer based on a copper complex,
at least one catalyst,
said composition being free of alkali metal halide and of oligo- or poly-carbodiimide.

2. The layer as claimed in claim 1, wherein said pipe is flexible.

3. The layer as claimed in claim 1, wherein said copper-based complex comprises a ligand chosen from phosphines, mercaptobenzimidazole, EDTA, acetylacetonate, glycine, ethylenediamine, oxalate, diethylenediamine, triethylenetetraamine, pyridine, diphosphone and dipyridyl or mixtures thereof.

4. The layer as claimed in claim 1, wherein said copper-based complex also comprises a halogenated organic compound.

5. The layer as claimed in claim 4, in which said halogenated organic compound is a bromine-based compound and/or an aromatic compound.

6. The layer as claimed claim 4, wherein said aromatic halogenated organic compound is chosen from decabromodiphenyl, decabromodiphenyl ether, bromo or chloro styrene oligomers, polydibromostyrene, tetrabromobisphenyl-A, tetrabisphenyl-A derivatives, and chloro dimethanedibenzo(a,e)cyclooctene derivatives, and mixtures thereof.

7. The layer as claimed in claim 4, wherein the copper:halogen mole ratio is from 1:1 to 1:3000.

8. The layer as claimed in claim 7, wherein said copper-based complex and said halogenated organic compound are in the form of a masterbatch.

9. The layer as claimed in claim 1, wherein the semicrystalline polyamide is chosen from PA11, PA12, aliphatic polyamides resulting from the condensation of an aliphatic diamine containing from 6 to 12 carbon atoms and of an aliphatic diacid containing from 9 to 12 carbon atoms, copolyamides 11/12 bearing either more than 90% of units 11 or more than 90% of units 12, polyphthalamides and polyamides comprising at least one minor unit derived from the polycondensation of a diamine with a polymerized fatty acid.

10. The layer as claimed in claim 1, wherein the polyolefin is an ethylene elastomeric copolymer chosen from an ethylene/propylene copolymer (EPR) grafted with maleic anhydride, an ethylene/butylene copolymer grafted with maleic anhydride, an ethylene/hexene copolymer grafted with maleic anhydride, an ethylene/octene copolymer grafted with maleic anhydride, and an ethylene/alkyl (meth)acrylate copolymer comprising a maleic anhydride function.

11. The layer as claimed in claim 1, wherein the plasticizer is N-butylbenzenesulfonamide (BBSA).

12. The layer as claimed claim 1, wherein the catalyst is chosen from phosphoric acid, phosphorous acid (H₃PO₃) and hypophosphorous acid (H₃PO₂), or a mixture thereof.

13. The layer as claimed in claim 12, wherein the amount of catalyst represents up to 3000 ppm, relative to the amount of polyamide.

14. The layer as claimed in claim 1, wherein the composition also comprises at least one additive chosen from impact modifiers, dyes, pigments, optical brighteners and UV stabilizers.

15. A composition comprising:
from 70% to 91% by weight of at least one semicrystalline polyamide with a mean number of carbon atoms per nitrogen atom, noted Nc, of greater than or equal to 7.5,
from 5% to 25% by weight of at least one polyolefin comprising an epoxy, anhydride or acid function, introduced by grafting or by copolymerization, and
from 3% to 20% by weight of at least one plasticizer,
from 0.05% to 2% by weight of at least one stabilizer based on a copper complex,
at least one catalyst,
said composition being free of alkali metal halide and of oligo- or poly-carbodiimide.

16. A process for preparing a composition as defined in claim 15, comprising the placing in contact:
of from 70% to 91% by weight of at least one semicrystalline polyamide with a mean number of carbon atoms per nitrogen atom, noted Nc, of greater than or equal to 7.5,
of from 5% to 25% by weight of a polyolefin comprising an epoxy, anhydride or acid function, introduced by grafting or by copolymerization, and
of from 3% to 20% by weight of a plasticizer,
of from 0.05% to 2% by weight of a stabilizer based on a copper complex,
of at least one catalyst,
said composition being free of alkali metal halide and of oligo- or poly-carbodiimide. Page 8

17. A pipe intended to be used in the exploitation of undersea (offshore) oil or gas deposits, comprising at least one layer obtained from a composition comprising:
from 70% to 91% by weight of at least one semicrystalline polyamide with a mean number of carbon atoms per nitrogen atom, noted Nc, of greater than or equal to 7.5,
from 5% to 25% by weight of at least one polyolefin comprising an epoxy, anhydride or acid function, introduced by grafting or by copolymerization, and
from 3% to 20% by weight of at least one plasticizer,
from 0.05% to 2% by weight of a stabilizer based on a copper complex,
at least one catalyst,
said composition being free of alkali metal halide and of oligo- or poly-carbodiimide.

18. The pipe as claimed in claim 17, wherein the semicrystalline polyamide is chosen from PA11, PA12, aliphatic polyamides resulting from the condensation of an aliphatic diamine containing from 6 to 12 carbon atoms and of an aliphatic diacid containing from 9 to 12 carbon atoms, copolyamides 11/12 bearing either more than 90% of units 11 or more than 90% of units 12, polyphthalamides and polyamides comprising at least one minor unit derived from the polycondensation of a diamine with a polymerized fatty acid.

19. The pipe as claimed in claim 17, wherein it also comprises at least one second layer formed from one or more metal elements, the second layer being in contact with the oil or gas conveyed, the layer being placed around the second layer so as to ensure the leaktightness.

20. The pipe as claimed in claim 17, wherein the pipe also comprises at least one third layer, made of metal or composite material, the third layer being placed around the layer so as to compensate for the internal pressure of the oil or gas conveyed.

21. The pipe as claimed in claim 17, wherein the pipe also comprises at least one fourth protective layer placed around the layer.

22. The pipe as claimed in claim 17, wherein said pipe is flexible.
